(19) United States
(12) Patent Application Publication
(10) Pub. No.: US 2007/0098955 A1
(43) Pub. Date: May 3, 2007

(54) Multi-layer tape for wire installation in aircraft

(76) Inventors: Emanuel Magoulas, Bellevue, WA (US); Lenny E. Lay, Stanwood, WA (US)

Correspondence Address: MACPHERSON KWOK CHEN & HEID, LLP, 2033 GATEWAY PLACE, SUITE 400, SAN JOSE, CA, 95110, US

(21) Appl. No.: 11/263,151

(22) Filed: Oct. 31, 2005

(51) Int. Cl. B32B 3/10

(52) U.S. Cl. 428/137

(57) ABSTRACT

A multi-layer tape and related methods are disclosed herein to provide improved wire installation in aircraft. For example, in accordance with one embodiment of the present invention, a multi-layer tape for securing electrical wiring to an aircraft includes a face stock layer, a scrim layer, a first adhesive layer adapted to secure the scrim layer to the face stock layer, and a second adhesive layer adapted to secure the multi-layer tape to a surface of the aircraft.

### TECHNICAL FIELD

The present invention relates generally to the installation of electrical wiring and, more particularly, to wiring installation in aircraft.

### BACKGROUND

Modern aircraft typically include significant amounts of electrical wiring. Installation of such wiring in aircraft is generally performed using various types of hardware supports such as loop clamps, tie straps, and mounts. These supports can be made from a variety of materials, such as plastic, metal, or composite materials including fiberglass or graphite reinforced resins.

FIG. 1 illustrates one example of a wire bundle installation using conventional hardware. As set forth in FIG. 1, wire installation hardware 100 is provided for securing an electrical wiring bundle 110. FIG. 2 illustrates a schematic representation of the wire installation hardware 100 used in the example of FIG. 1.

Unfortunately, conventional wire installation hardware such as that illustrated in FIGS. 1 and 2 can have significant drawbacks. In particular, installation of the hardware can necessitate specialized installation tools. In addition, installation of the hardware can require specialized training as well as significant amounts of manual labor, all of which can increase installation costs.

Accordingly, there is a need for an improved approach to the installation of electrical wiring in aircraft that overcomes the deficiencies in the prior art as discussed above. In particular, there is a need to provide for installation in a way that is less labor intensive and involves the use of fewer, more easily manageable parts.

### SUMMARY

In accordance with one embodiment of the present invention, a multi-layer tape for securing electrical wiring to an aircraft includes a face stock layer; a scrim layer; a first adhesive layer adapted to secure the scrim layer to the face stock layer; and a second adhesive layer adapted to secure the multi-layer tape to a surface of the aircraft.

In accordance with another embodiment of the present invention, a method of installing electrical wiring in an aircraft includes positioning the electrical wiring on a surface of the aircraft; providing a multi-layer tape comprising a face stock layer, a scrim layer, a first adhesive layer adapted to secure the scrim layer to the face stock layer, and a second adhesive layer adapted to secure the multi-layer tape to the surface of the aircraft; aligning the multi-layer tape over the electrical wiring; and affixing the multi-layer tape to the surface of the aircraft.

In accordance with another embodiment of the present invention, an aircraft includes a pressurized interior portion having an interior surface; electrical wiring; and a multi-layer tape adapted to secure the electrical wiring to the interior surface, wherein the multi-layer tape comprises: an Ultem™ face stock layer, a fiberglass mesh scrim layer, a first acrylic adhesive layer adapted to secure the fiberglass mesh scrim layer to the Ultem™ face stock layer, and a second acrylic adhesive layer adapted to secure the multi-layer tape to the interior surface.

In accordance with another embodiment of the present invention, a multi-layer tape for securing electrical wiring to an aircraft includes a first layer comprising a face stock material and a scrim material; and an adhesive layer adapted to secure the multi-layer tape to a surface of the aircraft.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates one example of a wire bundle installation using a conventional approach.

FIG. 2 illustrates a schematic representation of wire installation hardware used in the example of FIG. 1.

FIG. 3 illustrates a cross-sectional side view of a multi-layer tape in accordance with an embodiment of the present invention.

FIG. 4 illustrates a perspective view of a multi-layer tape in accordance with an embodiment of the present invention.

FIG. 5 illustrates a multi-layer tape installed on a surface in accordance with an embodiment of the present invention.

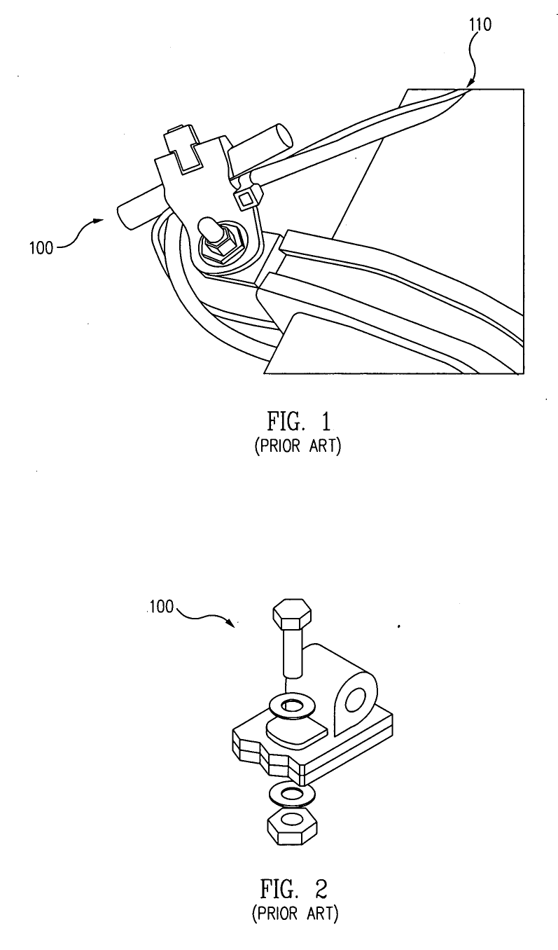

Embodiments of the present invention and their advantages are best understood by referring to the detailed description that follows. It should be appreciated that like reference numerals are used to identify like elements illustrated in one or more of the figures.

### DETAILED DESCRIPTION

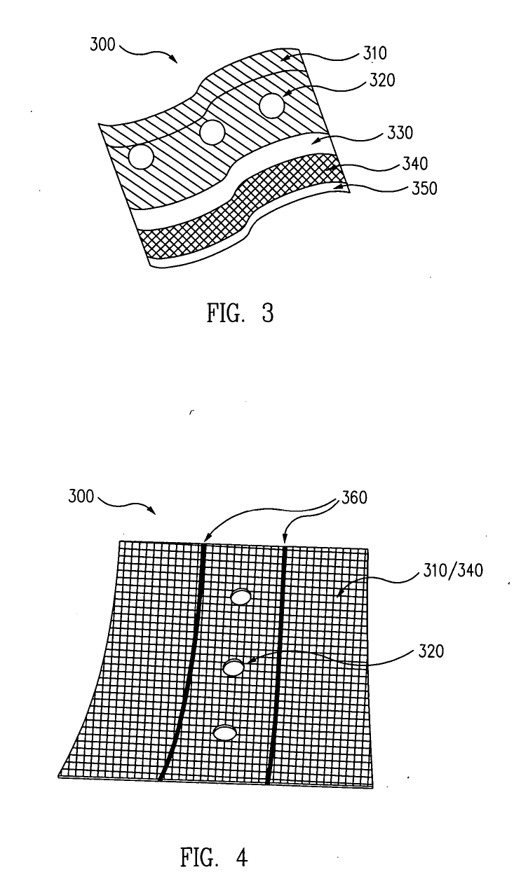

FIG. 3 illustrates a cross-sectional side view of a multi-layer tape 300 in accordance with an embodiment of the present invention. Various embodiments of multi-layer tape 300 can be used for securing electrical wiring to various surfaces of an aircraft for permanent, semi-permanent, or temporary wiring installations. In one embodiment, multi-layer tape 300 can be used to affix electrical wiring bundles to surfaces in pressurized interior portions of aircraft, such as surfaces comprised of fiber-reinforced thermoset plastic or other composite non-metallic materials in pressurized bulkhead zones.

In various embodiments, multi-layer tape 300 can be provided in one or more strips which collectively cover portions of electrical wiring. For example, in one embodiment, individual strips of multi-layer tape 300 can be installed over approximately 50 percent to 70 percent of a particular electrical wiring bundle sought to be installed on an aircraft surface.

Multi-layer tape 300 can be sized to permit installation of electrical wiring bundles having a variety of sizes. For example, in one embodiment, multi-layer tape 300 can be sized for installation of electrical wiring bundles having a diameter of approximately ⅝ inches or less.

As set forth in FIG. 3, multi-layer tape 300 includes a face stock layer 310, a plurality of apertures 320, a first adhesive layer 330, a scrim layer 340, and a second adhesive layer 350. Face stock layer 310 provides the external top surface of multi-layer tape 300 and is preferably fire-resistant. In various embodiments, face stock layer 310 can be comprised of polyester, silicon, a polyvinylfluoride (PVF) material such as Tedlar™, and/or an amorphous thermoplastic polyetherimide material such as Ultem™.

Scrim layer 340 is secured to face stock layer 310 by first adhesive layer 330. Scrim layer 340 provides reinforcement to stock face layer 310 and can aid in preventing the underlying layers of multi-layer tape 300 from being severed in the event that a portion of face stock layer 310 is inadvertently cut during installation. In one embodiment, scrim layer 340 can be implemented as a mesh comprised of a fiberglass woven fabric for improving fire resistance of multi-layer tape 300.

As illustrated, first adhesive layer 330 is situated between face stock layer 310 and scrim layer 330. Second adhesive layer is positioned on scrim layer 330 and is used to secure multi-layer tape 300 to an aircraft surface in order to facilitate installation of electrical wiring on the aircraft surface.

In various embodiments, first and second adhesive layers 330 and 350, respectively, can be implemented as acrylic adhesives, rubber adhesives, silicon adhesives, and/or other materials. It will be appreciated that each of first and second adhesive layers 330 and 350, respectively, can each be implemented using the same or different materials from each other. The use of first and second adhesive layers 330 and 350, respectively, also allows for less adhesive residue to be left behind on an aircraft surface in the event that the multi-layer tape 300 removed.

It will be appreciated that each of the various layers of multi-layer tape 300 can be implemented with any thickness as may be desired for particular installation applications. In one embodiment, face stock layer 310 can be implemented with a thickness in the range of approximately 4.3 mm to approximately 5 mm. In another embodiment, one or both of first and second adhesive layers 330 and 350, respectively, can be implemented with a thickness in the range of approximately 2 mm to approximately 5 mm. In yet another embodiment, first adhesive layer 330 can be implemented with a thickness of approximately 3 mm and second adhesive layer 350 can be implemented with a thickness of approximately 5 mm.

Apertures 320 may be optionally provided for venting moisture and/or other contaminants that may collect under multi-layer tape 300 after installation in order to reduce the likelihood of fungal buildup or other matter under multi-layer tape 300. In one embodiment, apertures 320 are implemented with a diameter of approximately ¼ inch. In another embodiment, apertures 320 can be omitted from multi-layer tape 300 and venting can be provided by gaps between individual strips of multi-layer tape 300.

In another embodiment, face stock layer 310 and scrim layer 340 may be integrated into a single layer including both face stock material and scrim material. In such an embodiment, first adhesive layer 330 may be omitted, and second adhesive layer 350 may be positioned on a bottom surface of the single face stock/scrim layer in order to facilitate installation of electrical wiring on the aircraft surface.

FIG. 4 illustrates a perspective view of multi-layer tape 300 in accordance with an embodiment of the present invention. As identified in the embodiment of FIG. 4, face stock layer 310 has been implemented with a substantially transparent material which allows scrim layer 340 (implemented as a fiberglass mesh in FIG. 4) to be visible through face stock layer 310. Optional apertures 320 are also apparent in FIG. 4 which extend through all layers of multi-layer tape 300.

As further illustrated in FIG. 4, a plurality of markings 360 can be optionally provided on face stock layer 310. Markings 360 can aid in aligning the multi-layer tape over electrical wiring during installation. In the embodiment set forth in FIG. 4, markings 360 are implemented with substantially parallel lines spaced apart at approximately 1.25 inches. However, it will be appreciated that markings 360 may be implemented on face stock layer 310 in accordance with any graphic or symbolic design as may be desired in particular wiring installations. In addition, markings 360 can be implemented using any desired color such as, for example, blue.

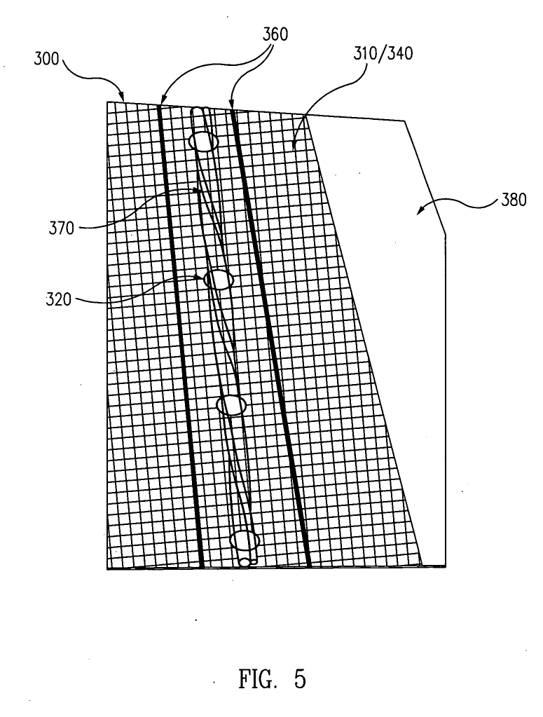

FIG. 5 illustrates multi-layer tape 300 installed on a surface 380 such as, for example, an aircraft surface in accordance with an embodiment of the present invention. As set forth in FIG. 5, electrical wiring 370 is shown being secured to surface 380 by a continuous strip of multi-layer tape 300.

During installation, electrical wiring 370 can be positioned (i.e. dressed) on surface 380. Multi-layer tape 300 can then be aligned over electrical wiring 370. It will be appreciated that through the use of markings 360, an installer can easily center multi-layer tape 300 over electrical wiring 370. Optional apertures 320 can also be conveniently aligned on top of electrical wiring 370. After multi-layer tape 300 has been aligned over electrical wiring 370, multi-layer tape 300 can be affixed to surface 380 by contacting second adhesive layer 350 with surface 380. As a result, electrical wiring 370 will be secured to surface 380 by multi-layer tape 300.

Although FIG. 5 illustrates a single multi-layer tape 300 strip installed on a single bundle of electrical wiring 370, it will be appreciated that other installation methods may be employed. For example, additional multi-layer tape 300 strips may be installed over electrical wiring 370 to further secure the electrical wiring 370 where desired, such as in locations where the electrical wiring 370 may be installed around corners. In another example, additional electrical wiring may be crossed over electrical wiring 370 and installed with additional multi-layer tape 300 strips.

It will be appreciated that multi-layer tape 300 in accordance with various embodiments of the present invention allows electrical wiring to be installed directly to aircraft interior surfaces without the use of more cumbersome wire mounting hardware. In comparison with hardware approaches, multi-layer tape 300 provides a variety of advantages. For example, multi-layer tape 300 can be installed on aircraft surfaces without specialized tools or training typically associated with conventional wire mounting hardware, thereby resulting in reduced installation time and costs. In addition, multi-layer tape 300 can provide reduced parts costs, weight savings, and reduced parts counts by decreasing the use of conventional wire mounting hardware in aircraft.

Moreover, because multi-layer tape 300 can be installed to substantially cover electrical wiring, it can provide protection for the electrical wiring as well as act as a vibration and noise dampening barrier. Various embodiments of multi-layer tape 300 constructed in accordance with materials described herein can also exhibit qualities well-suited for the aircraft environment such as fire resistance, reduced likelihood of electrical arcing, and low amounts of smoke and toxic gas emissions.

Embodiments described above illustrate but do not limit the invention. It should also be understood that numerous modifications and variations are possible in accordance with the principles of the present invention. For example, in some embodiments, multi-layer tape 300 may optionally be used in conjunction with various wire mounting hardware. Accordingly, the scope of the invention is defined only by the following claims.

We claim:

1. A multi-layer tape for securing electrical wiring to an aircraft, the multi-layer tape comprising:
a face stock layer;
a scrim layer;
a first adhesive layer adapted to secure the scrim layer to the face stock layer; and
a second adhesive layer adapted to secure the multi-layer tape to a surface of the aircraft.

2. The multi-layer tape of claim 1, wherein the face stock layer comprises a fire-resistant material.

3. The multi-layer tape of claim 1, wherein the face stock layer comprises a material selected from the group consisting of: a polyester material, a silicon material, a polyvinylfluoride (PVF) material, and an amorphous thermoplastic polyetherimide material.

4. The multi-layer tape of claim 1, wherein the scrim layer comprises a fiberglass mesh.

5. The multi-layer tape of claim 1, wherein at least one of the first and second adhesive layers comprise an adhesive selected from the group consisting of: an acrylic adhesive, a rubber adhesive, and a silicon adhesive.

6. The multi-layer tape of claim 1, wherein the surface of the aircraft is in a pressurized interior portion of the aircraft.

7. The multi-layer tape of claim 1, further comprising markings on the face stock layer, wherein the markings are adapted to aid in aligning the multi-layer tape over the electrical wiring.

8. The multi-layer tape of claim 7, wherein the markings comprise substantially parallel lines.

9. The multi-layer tape of claim 1, further comprising a plurality of apertures in the multi-layer tape.

10. A method of installing electrical wiring in an aircraft, the method comprising:
positioning the electrical wiring on a surface of the aircraft;
providing a multi-layer tape comprising:
a face stock layer,
a scrim layer,
a first adhesive layer adapted to secure the scrim layer to the face stock layer, and
a second adhesive layer adapted to secure the multi-layer tape to the surface of the aircraft;
aligning the multi-layer tape over the electrical wiring; and
affixing the multi-layer tape to the surface of the aircraft.

11. The method of claim 10, wherein the face stock layer comprises a fire-resistant material.

12. The method of claim 10, wherein the face stock layer comprises a material selected from the group consisting of: a polyester material, a silicon material, a polyvinylfluoride (PVF) material, and an amorphous thermoplastic polyetherimide material.

13. The method of claim 10, wherein the scrim layer comprises a fiberglass mesh.

14. The method of claim 10, wherein at least one of the first and second adhesive layers comprise an adhesive selected from the group consisting of: an acrylic adhesive, a rubber adhesive, and a silicon adhesive.

15. The method of claim 10, wherein the surface of the aircraft is in a pressurized interior portion of the aircraft.

16. The method of claim 10, wherein the multi-layer tape further comprises markings on the face stock layer, wherein the markings are adapted to aid in aligning the multi-layer tape over the electrical wiring.

17. The method of claim 16, wherein the markings comprise substantially parallel lines.

18. The method of claim 10, wherein the multi-layer tape further comprises a plurality of apertures in the multi-layer tape.

19. An aircraft comprising:
a pressurized interior portion having an interior surface;
electrical wiring; and
a multi-layer tape adapted to secure the electrical wiring to the interior surface, wherein the multi-layer tape comprises:
an Ultem™ face stock layer,
a fiberglass mesh scrim layer,
a first acrylic adhesive layer adapted to secure the fiberglass mesh scrim layer to the Ultem™ face stock layer, and
a second acrylic adhesive layer adapted to secure the multi-layer tape to the interior surface.

20. The aircraft of claim 19, wherein the multi-layer tape further comprises markings on the Ultem™ face stock layer, wherein the markings are adapted to aid in aligning the multi-layer tape over the electrical wiring.

21. A multi-layer tape for securing electrical wiring to an aircraft, the multi-layer tape comprising:
a first layer comprising a face stock material and a scrim material; and
an adhesive layer adapted to secure the multi-layer tape to a surface of the aircraft.
